(19) United States
(12) Patent Application Publication
(10) Pub. No.: US 2015/0340937 A1
(43) Pub. Date: Nov. 26, 2015

(54) BISTABLE ELECTROMAGNETIC ACTUATOR AND SURGICAL INSTRUMENT

(71) Applicant: OLYMPUS WINTER & IBE GMBH, Hamburg (DE)

(72) Inventor: Martin WIETERS, Hamburg (DE)

(73) Assignee: OLYMPUS WINTER & IBE GMBH, Hamburg (DE)

(21) Appl. No.: 14/814,733

(22) Filed: Jul. 31, 2015

Related U.S. Application Data
(63) Continuation of application No. PCT/EP2014/000061, filed on Jan. 14, 2014.

(30) Foreign Application Priority Data
Feb. 7, 2013 (DE) 10 2013 202 019.8

(51) Int. Cl. H02K 33/16; H02K 1/17

(52) U.S. Cl. CPC H02K 33/16; H02K 1/17

(57) ABSTRACT

A bistable electromagnetic actuator including: a tube; a stator arranged outside the tube, and a rotor mounted in the tube so as to be displaceable axially in the longitudinal direction, is the rotor being at least partially formed of one or more of a paramagnetic and ferromagnetic material, the rotor being reversibly moved between a first position and a second position by applying an electromagnetic field. Wherein the stator includes: two ring permanent magnets that are axially polarized in opposite directions, a coil for generating the electromagnetic field, and a magnetic return element having two stator pole shoes. Wherein, the magnetic return element with the stator pole shoes encloses the coil, one of the stator pole shoes is arranged on each of two sides of the coil between the coil and ring permanent magnets, the rotor has two rotor pole shoes, and an axial width of the stator pole shoes is smaller than an axial width of the rotor pole shoes.

### CROSS-REFERENCE TO RELATED APPLICATION

The present application is a continuation of PCT/EP2014/000061 filed on Jan. 14, 2014, which is based upon and claims the benefit to DE 10 2013 202 019.8 filed on Feb. 7, 2013, the entire contents of each of which are incorporated herein by reference.

### BACKGROUND

1. Field

The present application relates to a bistable electromagnetic actuator, in particular for a surgical instrument, comprising a stator arranged outside a tube, and a rotor that is mounted in the tube so as to be displaceable axially in the longitudinal direction, which is of a paramagnetic and/or ferromagnetic material, at least in part, and which can be reversibly moved between a first position and a second position by applying an electromagnetic field, wherein the stator is provided with two ring permanent magnets that are axially polarized in opposite directions, a coil for generating the electromagnetic field, a magnetic return element having two stator pole shoes, and to a surgical instrument.

2. Prior Art

Bistable electromagnetic actuators have a rotor that is held in a permanent magnetic field in one of two extreme positions and can be transferred from one stable position to the other stable position by switching an electromagnetic field. This allows switches, for example, to be actuated. In the case of surgical instruments, especially endoscopes, these small-size actuators can be used, for example. to change a focus or an enlargement of an optical system, or to change a direction of view. This is done by moving an optical component through the actuator, the optical component being located in or on the rotor of the actuator.

A linear motor for optical systems, such as endoscopes, is known from DE 10 2008 042 701 A1. The motor has a stator with two permanent magnets which are polarized in the same direction and are magnetically connected to each other with a magnetic return element. A coil is arranged between the magnets. On the side next to each magnet, a pole shoe is also magnetically connected to the magnetic return element. The rotor of the motor comprises a yoke consisting of a soft magnetic material, which is magnetically engaged with the permanent magnet of the stator. When current is applied to the coil, the rotor can be moved out of the resting position in the longitudinal direction.

The rotor according to DE 10 2008 042 701 A1 consists of a tubular, soft magnetic element so that, given the resulting friction of the tubular rotor on the tube, strong force must be expended to move the rotor out of one position into the other position. Furthermore, the linear motor according to DE 10 2008 042 701 A1 is comparably large sized.

### SUMMARY

Accordingly, an object is to provide a small-size, bistable electromagnetic actuator and a surgical instrument with a corresponding bistable electromagnetic actuator, wherein greater displacement forces can be exerted on the rotor with a small design.

This objective is achieved with a bistable electromagnetic actuator, in particular for a surgical instrument, comprising a stator arranged outside a tube, and a rotor that is mounted in the tube so as to be displaceable axially in the longitudinal direction, which is of a paramagnetic and/or ferromagnetic material, at least in part, and which can be reversibly moved between a first position and a second position by applying an electromagnetic field, wherein the stator is provided with two ring permanent magnets that are axially polarized in opposite directions, a coil for generating the electromagnetic field, a magnetic return element having two stator pole shoes, in which the magnetic return element with the stator pole shoes encloses the coil, and the stator pole shoes are arranged on both sides of the coil between the coil and ring permanent magnets, wherein the rotor has two rotor pole shoes, wherein an axial width of the stator pole shoes is smaller than an axial width of the rotor pole shoes.

The actuator achieves the underlying object of being able to minimize the coil current and the power dissipation in the coil by increasing the efficiency of the coil. This is achieved by the geometry of the actuator elements. The geometry is based on the fact that the magnetic return element with the stator pole no longer encloses the coil as well as the ring magnets as disclosed in DE 10 2008 042 701 A1, but rather only the coil, whereas the ring magnets are arranged outside of the stator pole shoes. Axially magnetized magnetic rings are used for this, since by using them, no radially arranged soft iron of the magnetic return element is necessary. For this reason, the stator can be realized in a smaller radial construction space. Since the stator pole shoes are arranged between the permanent magnets and the coil, this increases the coil efficiency since the pole shoes are directly connected to the magnetic return. This can reduce the axial length of the stator and hence the axial length of the rotor as well.

Since the rotor itself has rotor pole shoes, it has a central, radial tapering so that a pole shoe is formed on each of its ends. Consequently, the rotor only contacts the tube at the locations of the pole shoes, and not the entire surface. The friction between the rotor and the tube in which the rotor is located is thereby reduced. This increases the efficiency of switching since less friction resistance must be overcome. In addition, the negative influence of, for example, straightness errors or curves is reduced by the smaller fit on two small contact surfaces or respectively lines of contact.

Overall, this yields favourable coil or respectively actuator efficiency, and a favourable balance of retaining force and switching force.

When the axial width of the stator pole shoes is smaller than an axial stroke of the actuator between the first position and second position, significant differences between the retaining force and switching force can be realized.

Advantageously, the rotor with the rotor pole shoes has an overall length in the axial direction which is greater than the outside distance of the stator pole shoes in the axial direction. A distance between the axial midplanes of the rotor pole shoes can be greater than the distance between the axial midplanes of the stator pole shoes. By means of such features, the balance between the retaining force and switching force can be favorably adjusted, and the switching force can be increased.

When the stator pole shoes have an equal axial width amongst each other, and/or the stator pole shoes have an equal axial width amongst each other, and/or the stator and/or the rotor(s) is or are formed symmetrically across a plane of symmetry, a symmetrical design of the actuator in the axial direction is realized so that the same retaining force predominates at the two end positions, or respectively at the first position and the second position, and equivalent switching force can be applied to change the position of the rotor in the actuator. In addition, only some of the cited geometric dimensions can be symmetrically realized. If the actuator is subject to a continuous load, for example from a side, it can be advantageous to interrupt the overall symmetry of the actuator in an axial direction and implement greater retaining force and/or switching force in one position than in another position.

The rotor in the first and/or second position can lie against a stop. The stop can be arranged so that the force on the rotor in this position generated by the permanent magnets presses or draws the rotor further toward the stop against which the rotor rests.

In one development, in an end position, in particular the first or second position, the rotor pole shoe arranged at the end position at least partially covers the stator pole shoe that is opposed to the rotor pole shoe in the axial direction, wherein a midplane of the rotor pole shoe arranged at the end position extends in the axial direction towards the end position beyond a midplane of the stator pole shoe that is opposed to the rotor pole shoe. This relates to the rotor pole shoe or respectively stator pole shoe that is arranged closer to the momentary end position in an axial direction. In the case of an endoscope, this would be the distal pole shoe of the stator and rotor in the distal end position. These lie opposite each other. In the proximal end position, these are the proximal pole shoes of the stator and rotor. These also lie opposite each other.

In an end position, the rotor pole shoe not arranged in the end position also can completely cover the stator pole shoe that is opposed to the rotor pole shoe in the axial direction, wherein a midplane of the rotor pole shoe not arranged at the end position extends in the axial direction towards the end position beyond a midplane of the stator pole shoe that is opposed to the rotor pole shoe. With the example of the endoscope, these are, for example, the proximal pole shoes of the rotor and stator and vice versa in the distal end position of the rotor.

These two situations individually or together mean that a very stable and strong retaining force is realized with applying a small current to the coil at the respective end position due to the guidance of the magnetic flux which is favourable for this. Furthermore, this strongly increases the switching force acting on the rotor.

Finally, a surgical instrument is also provided, in particular an endoscope, with the bistable electromagnetic actuator described above. Since the actuator can be constructed very small, it can also be implemented in an endoscope with a narrow endoscope shaft.

Further features will become apparent from the description of the embodiments together with the claims and the included drawings. Embodiments can fulfill individual features or a combination of several features.

### BRIEF DESCRIPTION OF THE DRAWINGS

The embodiments are described below, without restricting the general intent of the invention, based on exemplary embodiments with reference to the drawings, whereby we expressly refer to the drawings with regard to the disclosure of all details according to the invention that are not explained in greater detail in the text. In the figures:

FIG. 1 illustrates a schematic cross-section of an actuator,

FIG. 2 illustrates a section of the distal part of the actuator according to FIG. 1,

FIG. 3 illustrates a schematic representation of a proximal part of the actuator according to FIG. 1 and FIG. 4, the retaining forces dependent on the rotor position, and switching forces of an actuator in comparison to a conventional actuator, and

FIG. 4 illustrates a force/path diagram for retaining and switching forces of a disclosed actuator in comparison to a known actuator.

In the drawings, the same or similar types of elements and/or parts are provided with the same reference numbers so that a corresponding re-introduction can be omitted.

### DETAILED DESCRIPTION

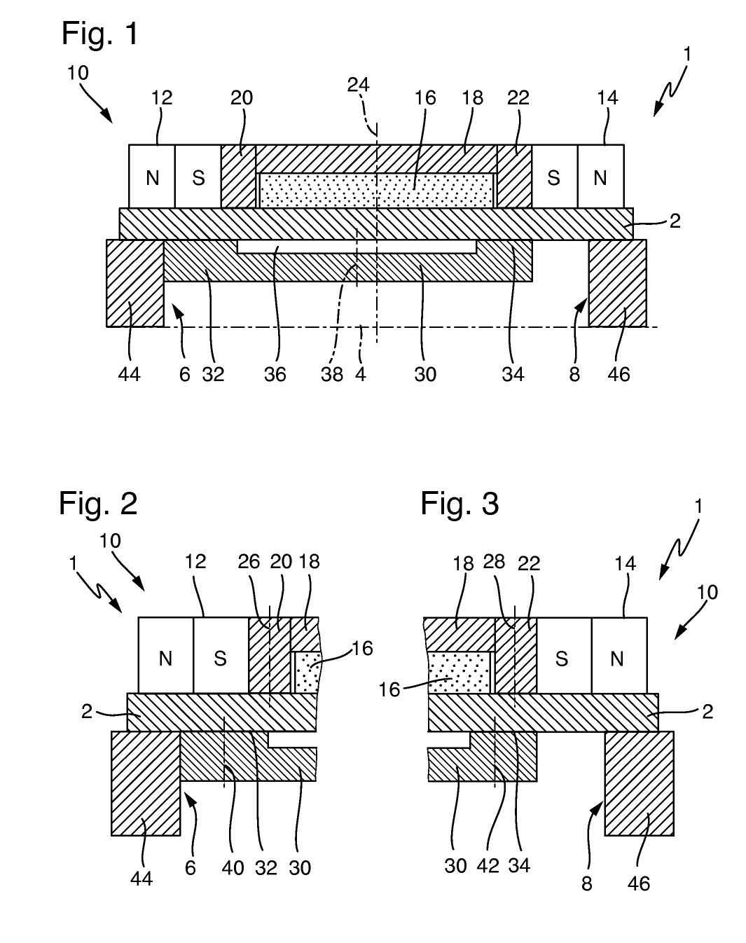

FIG. 1 shows a cross-section of a bistable electromagnetic actuator 1. The actuator is substantially rotationally symmetrical about the central axis 4, and only one-half of the actuator 1 is shown. Mirroring across the central axis 4 yields the entire section of the actuator 1.

In the following, the actuator 1 will be described as if it was located in a surgical instrument, i.e., in an endoscope with a distal end and proximal end. The distal direction is to the left in FIGS. 1 to 3, and the proximal direction is to the right.

A stator 10 is arranged radially outside of a tube 2 and has two ring magnets 12, 14 that are axially magnetized in opposite directions so that the south poles of the magnets lie opposite each other in FIG. 1. When integrated in an endoscope, the ring magnet 12 is a distal ring magnet, and the ring magnet 14 is a proximal ring magnet.

A cylindrical coil 16 is symmetrically arranged between the ring magnets 12 and 14, and a magnetic return element 18 which is also cylindrical is arranged radially outside of the coil 16 and consists of a soft magnetic material which radially abuts the ring magnets 12, 14 flush to the outside. The magnetic return element 18 terminates distally in a distal stator pole shoe 20 and proximally in a proximal stator pole shoe 22. The magnetic return element 18 and stator pole shoes 20, 22 can be designed as a single part or consist of different parts which are all soft magnetic. The distal and proximal pole shoes 20, 22 are arranged between the coil 16 and the distal and proximal ring magnets 12, 14. Overall, this yields a flush, radial outer terminating surface. The stator 10 according to FIG. 1 is symmetrical in the axial direction across a plane of symmetry 24.

The actuator 1 according to FIG. 1 has a rotor 30 radially within the tube 2 which consists, in particular entirely, of a soft magnetic material. This rotor 30 tapers in the middle and terminates in a distal rotor pole shoe 32 and a proximal rotor pole shoe 34, wherein the distal rotor pole shoe 32 substantially is opposed to the distal stator pole shoe 20, and the proximal rotor pole shoe 34 substantially is opposed to the proximal stator pole shoe 22. The rotor 30 tapers in the middle so that it leaves open a gap 36 toward the tube 2. Since the rotor 30 only contacts the tube 2 with the inner surfaces of the pole shoes 32, 34, friction is reduced, and a non-tipping arrangement of the rotor 30 in the tube 2 is ensured. The rotor 30 is symmetrical across a plane of symmetry 38 in the axial direction.

The movement of the rotor 32 to its distal and proximal side is limited by a distal stop 44 and a proximal stop 46. In contrast to the rotor 30 arranged to be axially movable in the tube 2, the stops 44, 46 are fixed in an axial direction.

FIG. 1 shows a situation in which the rotor 30 is held in a first position 6 by the permanent magnets 12, 14 in which the rotor 30 lies against the distal stop 45. The second position 8 would be the position in which the rotor 30 lies against the proximal stop 46.

FIGS. 2 and 3 show additional details of the geometry of the actuator 1 from FIG. 1. FIG. 2 shows that the axial width of the distal rotor pole shoe 32 is greater than the axial width of the distal stator pole shoe 20. It is also shown that in the first position 6 in which the rotor 30 lies against the distal stop 45, there is still a partial overlap between the distal rotor pole shoe 32 and the distal stator pole shoe 20. To a great extent, the distal rotor pole shoe 32 overlaps the distal ring magnet 12 in this position 6.

FIG. 2 also shows the axial midplanes 26 of the distal stator pole shoe 20 and 40 of the distal rotor pole shoe 32. In the portrayed first position 6, the axial midplane 40 of the distal rotor pole shoe 32 is distally assigned to the axial midplane 26 of the distal stator pole shoe 20. Since the rotor 30 with its distal rotor pole shoe 32 is arranged closer to the distal ring magnet 12, the distal ring magnet 12 exerts a greater attraction on the rotor pole shoe 32 than the proximal ring magnet 14 exerts on the proximal rotor pole shoe 34 of the rotor 30. This holds the rotor 30 in the first position 6.

FIG. 3 shows a section in the proximal region of the actuator 1 in the event that the rotor 30 assumes the first position 6 on the distal stop 44. This causes the proximal rotor pole shoe 34 to overlap the proximal stator pole shoe 22 along its entire width. At the same time, the midplane 42 of the proximal rotor pole shoe 34 is arranged distal to the midplane 28 of the proximal stator pole shoe 22. There is no or only a slight overlap between the rotor 30 and the proximal ring magnet 14.

If a change in position from the first position 6 to the second position 8 by the rotor 30 is desired, a current is applied to the coil 16, and the magnetic field generated electromagnetically by the coil 16 passes through the magnetic return element 18 and the stator pole shoes 20, 22 and through the tube 2 into the pole shoes 32, 34 of the rotor 30 in addition to the permanent magnetic fields of the ring permanent magnets 12, 14. In this case, the magnetic field generated by the coil 16 is oriented so that it supports the magnetic field which is generated by the ring magnet 14 and counteracts the magnetic field generated by the ring magnet 12. Since the geometry shown in FIGS. 1 to 3 of the proximal rotor pole shoe 34 completely covers the proximal stator pole shoe 22, a very efficient magnetic flux is realized in this case, and a strong switching force is exerted on the rotor 30. At the same time, the retaining force which is exerted by the distal ring magnet 12 is reduced. After switching, i.e., after the rotor 30 reaches the second position 8, the application of current to the coil 16 is interrupted, and it takes on the retaining force of the permanent magnetic field of the ring magnet 14.

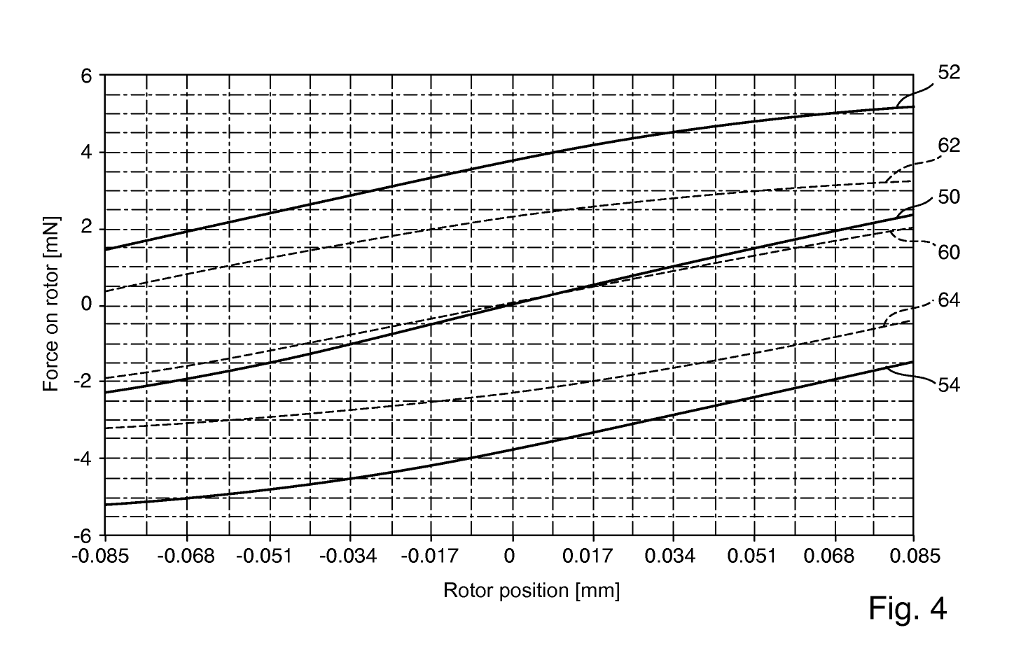

In a force/path diagram, FIG. 4 shows the dependency of the retaining forces or respectively switching forces on the rotor position in the actuator of an actuator 1 in FIGS. 1 to 3 on the one hand, and a conventional actuator on the other hand which has comparable dimensions. It can be seen that the retaining force 50 of the actuator 1 in FIGS. 1 to 3 exceeds the retaining force 60 of the known arrangement by about 15% which is illustrated in that the slope of the curve 50 is about 15% steeper than the slope of the curve 60.

The solid and dashed curves 52, 54, 62 and 64 each show the positive or respectively negative switching forces, i.e., the forces acting on the rotor depending on its position when a positive or negative current is applied to the respective coil. All the curves are symmetrical relative to a rotation of 180° about the origin of the coordinate system since the relevant actuators are constructed symmetrically.

The curves 52 and 62 and the curves 54 and 64 describe the switching forces on the rotors when a switching signal is positive or respectively when a switching signal is negative. With the actuator 1 in FIGS. 1 to 3, there is a significant increase in the switching forces. With the example of the curves 52 and 62, it is clear that the jump from the retaining force to the switching force in the actuator 1 in FIGS. 1 to 3 at the rotor position −0.085 mm rose by nearly 70% in comparison to the conventional actuator, i.e., the difference between the curves 62 and 60 on one hand in comparison to the difference between the curves 52 and 50 on the other hand, whereas at position +0.085 mm where the absolute differences between the switching force and retaining force are less, the jump means a relative increase of about 270%.

When the rotor is at position −0.085 mm, it is held in this position with a retaining force of about −2 mN. In absolute values, the diagram also reveals that the force acting on the rotor is only about 0.4 mN with the conventional actuator when a positive switching signal is applied, whereas this force is almost nearly 1.5 mN with the actuator 1 in FIGS. 1 to 3. Consequently, the force applied to the actuator is already greater by a factor of almost 4 at the beginning of the switching procedure than with a conventional actuator; the switching procedure therefore begins faster, and the rotor 30 leaves its previous position faster. Since the force acting on the actuator is greater over the entire switching process with the actuator 1 in FIGS. 1 to 3 than with the conventional actuator, the entire switching process is also faster.

Faster switching is realized with an equivalent size since the geometry leads to a more efficient use of the permanent magnets 12, 14 and the coil 16.

All named features, including those to be taken from the drawings alone, and individual features, which are disclosed in combination with other features, are considered individually and in combination as essential to the invention. Embodiments can be realized by the individual features, or a combination of several features.

### LIST OF REFERENCE NUMBERS

1 Actuator
2 Tube
4 Central axis
6 First position
8 Second position
10 Stator
12 Distal ring magnet
14 Proximal ring magnet
16 Coil
18 Magnetic return element
20 Distal stator pole shoe
22 Proximal stator pole shoe
24 Plane of symmetry of the stator
26 Midplane of the distal stator pole shoe
28 Midplane of the proximal stator pole shoe
30 Rotor
32 Distal rotor pole shoe
34 Proximal rotor pole shoe
36 Gap
38 Plane of symmetry of the rotor
40 Midplane of the rotor stator pole shoe
42 Midplane of the proximal stator pole shoe
44 Distal stop
46 Proximal stop
50 Retaining force (according to the invention)
52 Force from a positive pulse (according to the invention)
54 Force from a negative pulse (according to the invention)
60 Retaining force (conventional actuator)
62 Force from a positive pulse (conventional actuator)
64 Force from a negative pulse (conventional actuator)

What is claimed is:

1. A bistable electromagnetic actuator comprising:
a tube;
a stator arranged outside the tube, and
a rotor mounted in the tube so as to be displaceable axially in the longitudinal direction, is the rotor being at least partially formed of one or more of a paramagnetic and ferromagnetic material, the rotor being reversibly moved between a first position and a second position by applying an electromagnetic field,
wherein the stator comprises:
two ring permanent magnets that are axially polarized in opposite directions,
a coil for generating the electromagnetic field, and
a magnetic return element having two stator pole shoes,
wherein the magnetic return element with the stator pole shoes encloses the coil, one of the stator pole shoes is arranged on each of two sides of the coil between the coil and ring permanent magnets, the rotor has two rotor pole shoes, and an axial width of the stator pole shoes is smaller than an axial width of the rotor pole shoes.

2. The bistable electromagnetic actuator according to claim 1, wherein the axial width of the stator pole shoes is less than an axial stroke of the actuator between the first position and the second position.

3. The bistable electromagnetic actuator according to claim 1, wherein the rotor with the rotor pole shoes has an overall length in the axial direction that is greater than an outer spacing of the stator pole shoes in the axial direction.

4. The bistable electromagnetic actuator according to claim 1, wherein a spacing between axial midplanes of the rotor poles shoes is greater than a spacing of axial midplanes between the stator pole shoes.

5. The bistable electromagnetic actuator according to claim 1, wherein the stator pole shoes have an equal axial width.

6. The bistable electromagnetic actuator according to claim 1, wherein the rotor pole shoes have an equal axial width.

7. The bistable electromagnetic actuator according to claim 1, wherein one or more of the stator and the rotor are each configured symmetrically across a plane of symmetry.

8. The bistable electromagnetic actuator according to claim 1, further comprising one or more stops for limiting movement of the rotor in the first and/or second position.

9. The bistable electromagnetic actuator according to claim 1, wherein in an end position, the rotor pole shoe arranged in the end position at least partially covers the stator pole shoe in the axial direction that is opposed to the rotor pole shoe, wherein a midplane of the rotor pole shoe arranged at the end position extends in the axial direction towards the end position beyond a midplane of the stator pole shoe that is opposed to the rotor pole shoe.

10. The bistable electromagnetic actuator according to claim 9, wherein the end position is one or more of the first and second position.

11. The bistable electromagnetic actuator according to claim 1, wherein in an end position, the rotor pole shoe not arranged in the end position completely covers the stator pole shoe in the axial direction that is opposed to the rotor pole shoe, wherein a midplane of the rotor pole shoe not arranged at the end position extends in the axial direction towards the end position beyond a midplane of the stator pole shoe that is opposed to the rotor pole shoe.

12. A surgical instrument comprising:
a bistable electromagnetic actuator comprising:
a tube;
a stator arranged outside the tube, and
a rotor mounted in the tube so as to be displaceable axially in the longitudinal direction, is the rotor being at least partially formed of one or more of a paramagnetic and ferromagnetic material, the rotor being reversibly moved between a first position and a second position by applying an electromagnetic field,
wherein the stator comprises:
two ring permanent magnets that are axially polarized in opposite directions,
a coil for generating the electromagnetic field, and
a magnetic return element having two stator pole shoes,
wherein the magnetic return element with the stator pole shoes encloses the coil, one of the stator pole shoes is arranged on each of two sides of the coil between the coil and ring permanent magnets, the rotor has two rotor pole shoes, and an axial width of the stator pole shoes is smaller than an axial width of the rotor pole shoes.

13. The surgical instrument of claim 12, wherein the surgical instrument is an endoscope.
